(19) United States
(12) Patent Application Publication
(10) Pub. No.: US 2015/0144462 A1
(43) Pub. Date: May 28, 2015

(54) TRANSPORT DEVICE

(71) Applicant: WEISS GmbH, Buchen (DE)

(72) Inventor: Dieter Weiss, Walldurn (DE)

(21) Appl. No.: 14/343,317

(22) PCT Filed: Sep. 4, 2012
(86) PCT No.: PCT/EP2012/067180

§ 371 Date: Feb. 10, 2015

(30) Foreign Application Priority Data
Sep. 9, 2011 (DE) 10 2011 113 000.8

(51) Int. Cl. B65G 35/06; B65G 54/02

(52) U.S. Cl. CPC B65G 35/06; B65G 54/02
USPC 198/619; 198/793

(57) ABSTRACT

The present invention relates to a transport device for transporting objects along a conveyor track. The transport device comprises a drive system having at least two stationary stator elements spaced apart from one another, which interact with a rotor element that is arranged on a transport element that is suitable for receiving at least one object and can be moved along the conveyor track. A distance between the stator elements ran a direction parallel to the conveyor track is shorter than the longitudinal extension of the rotor element.

The present invention relates to a transport apparatus for the transport of objects along a transport track.

Such transport apparatus serve, for example, to transport workpieces between different processing stations or assembly stations of an assembly line. The objects are in this respect moved along a transport track which has straight and/or curved sections. Transport apparatus are preferably used which have a closed transport track.

It is of considerable importance that such transport apparatus work reliably to minimize downtimes of the corresponding assembly line. The transport apparatus should nevertheless be inexpensive in manufacture and assembly.

The object of providing such a transport apparatus is satisfied by a transport apparatus having the features of claim 1.

In accordance with the invention, the transport apparatus for the transport of objects along a transport track comprises a drive system which has at least two stationary elements which are spaced apart from one another spatially and which cooperate with a rotor element which is arranged at a transport element suitable for receiving at least one object and movable along the transport track. A section between the stator elements is smaller in a direction parallel to the transport track than a longitudinal extent of the rotor element in just this direction.

In other words, the transport apparatus makes use of at least two fixedly arranged drive units—but also of more in dependence on the length and quality of the transport track—which form a drive system together with a movable object carrier in the form of a transport element or with the rotor element fastened thereto. The drive system does not extend continuously along the transport track, but rather comprises discrete units which are spatially separate from one another. A drive system is, for example, to be understood as a drive system extending continuously along the transport track which comprises a plurality of modules which are joined together and which form a throughgoing stator (long stator). In contrast to this, drive energy is only supplied selectively to the transport element in the transport apparatus in accordance with the present invention by stator elements arranged in a distributed manner.

In order always to be able to provide a sufficiently larger drive moment for moving the transport element, the distance between the stator elements is dimensioned such that at least one of the stator elements cooperates at all times with the rotor element attached to the transport element. In other words. It is ensured that the transport element can be moved in the desired manner via a control of the rotor element and/or of at least one of the stator elements. A suitable positioning of the transport element in predefined positions of rest, for example for processing and/or assembling the object arranged on the transport element is also thus made possible.

It is understood that in principle any desired number of stator elements can be provided to be able to provide a reliable drive along the total transport track. The stator elements do not have to be arranged at regular intervals if the design of the transport track makes this necessary.

The transport apparatus in accordance with the invention allows a reliable operation of the transport apparatus by the ensuring of a cooperation of the rotor element with at least one of the stator elements at all times—i.e. independently of the position of the transport element. Manufacturing costs and installation costs are saved by the geometrical design of the drive system using discrete, spatially spaced apart stator elements since no substantially uninterrupted stator element has to be provided. A sufficiently exact movement and positioning of the transport element is nevertheless made possible by a suitable dimensioning of the rotor element and of the distances between the stator elements. In addition, the maintenance of the transport apparatus and the construction space taken up by the transport apparatus is noticeably reduced.

Advantageous embodiments of the invention are set forth in the dependent claims, in the description and in the drawings.

To ensure that a sufficiently large propulsion force can be supplied to the transport element at all times, the spatial distance between the stator elements, the longitudinal extent of the stator elements—which are in particular substantially of equal length—and the longitudinal extent of the rotor elements can be coordinated with one another in a suitable manner. The named amounts are in particular coordinated with one another such that ultimately the sum of all sections of the stator element cooperating with the rotor element corresponds at all times—i.e. Independently of the position of the transport element—to at least the amount of the longitudinal extent of one of the stator elements parallel to the transport track. In other words, at least one stator element cooperates in full length with the rotor element at any given time, for example. If the transport element moves onward, states occur in which, for example, two stator elements each cooperate with the rotor element with at least half of their longitudinal extent or one stator element with ⅓ of its length and a further stator element with ⅔ of its length. The propulsion force which can be supplied to the transport element therefore always corresponds to the force which a stator element can apply at a maximum. It is admittedly also possible to provide a larger spatial distance between two stator elements and/or to design the stator elements or the rotor element as shorter; however, the above-described configuration has proved advantageous in many cases.

In accordance with an embodiment, the spatial distance between the stator elements is larger than half the longitudinal extent of the stator elements parallel to the transport track. Such a dimensioning provides good balance between the dynamics which can be generated by the drive system and the drive components required therefor. It is generally also possible to arrange the stator elements closer to one another—for example also only in specific sections—to be able to take account of special dynamic parameters and/or embodiments of the transport track. It is understood that the manufacturing costs of the transport apparatus also depend inter alia on the ratio of the total length of all stator elements with respect to the length of the transport track. Noticeable cost reductions without relevant losses in the transport dynamics and in the precision of the transport movement are already achieved from a ratio of 1:1.5 onward. The named ratio can, for example, amount to approximately 1:3.5 to 1:5.5. It has furthermore been found in practice that, for example distances between the stator elements of more than 0.5 m, preferably around 1 m, are suitable in many cases.

Provision can be made that the stator elements substantially have the same construction and in particular have a curvature-free longitudinal extent. I.e. the stator elements have a modular character and can thus be used in the most varied transport track embodiments.

The stator elements can comprise coils which cooperate with permanent magnets of the rotor element. The stator elements and the rotor element thus form a linear motor with a stator which comprises discrete, mutually spaced apart elements with coil arrangements.

The stator elements can be individually controllable to be able to ensure an exact positioning and/or acceleration of the transport element. In specific applications, the demands on a precision of the transport movement are lower and cost factors are in the foreground. It can then be advantageous if all or some of the stator elements are connected in parallel and can be controlled together. For example, the stator elements are supplied with energy in parallel from an amplifier so that the number of the components required for controlling the transport apparatus is minimized. If a specific apparatus is again to be controlled more precisely for another application, the parallel connection of the motors can be replaced with an individual control. An adaptation of the transport apparatus to the respective current demands can thus be carried out with minimal effort.

A simplification of the structure of the transport apparatus is achieved when the rotor element is divided into segments which are arranged spatially separate from one another, viewed in the longitudinal direction of the transport track, such that at least one of the segments cooperates with one of the stator elements at all times—i.e. independently of the position of the transport element. This embodiment of the rotor element is in particular advantageous when the transport element comprises a plurality of separate transport units which are coupled to one another and are in particular of the same construction. In this respect, at least one segment of the rotor element can be associated with each of the transport units.

In accordance with an advantageous embodiment, the stator elements are arranged separately from the transport track. I.e. they are not integrated into the transport track or directly fastened to it. The stator elements are in particular arranged offset in parallel to the transport track. For example, a spatial distance between the stator elements and the transport track in a direction perpendicular to the longitudinal extent of the transport track can be larger than a spatial distance between the rotor element and the transport track in a direction perpendicular to the longitudinal extent of the transport track. Alternatively or additionally, the spatial distance between the stator elements and the transport track can be larger than a spatial distance between a guide means provided for guiding the transport element along the transport track and the transport track, with the two above-named distances likewise relating to a direction perpendicular to the longitudinal extent of the transport track. It is generally also possible that the spatial distance between the guide means and the transport track is smaller than the spatial distance between the rotor element and the transport track.

The rotor element is in particular arranged such that it is arranged between the stator element and the transport track on a passing of a stator element. In figurative terms, the rotor element in this embodiment of the transport apparatus moves between the stator element and the transport track past the stator element.

It is furthermore possible that a guide means is provided at the transport element for guiding the movement of the transport element along the transport track. The guide means is in this respect arranged such that it is arranged between the stator element and the transport track on a passing of a stator element.

The transport track can comprise a rail which guides the transport element along the transport track, with the transport element comprising rollers which are arranged opposite one another with respect to the rail and which are in contact with side surfaces of the rail. In other words, the transport apparatus is similar to a monorail to a certain extent in this respect. The rollers of the transport element in this respect do not lie on the rail, but engage laterally around it to ensure a guidance of the transport element which is as good as possible.

The stator elements can each have two stator units which are arranged opposite one another at both sides of a section of the transport rail. The stator units are, for example, arranged symmetrically with respect to the transport track—e.g. with respect to a center plane or plane of symmetry extending in the longitudinal direction of the transport track. The rotor element can accordingly have at least two functional sections which are arranged offset in parallel with respect to the transport track and which each cooperate with one of the stator units, i.e. the functional sections can, for example, likewise be arranged symmetrically with respect to the transport track.

It is effected by the above-described embodiment that the forces acting laterally on the transport element by the drive system are compensated, whereby the load on the device guiding the transport element is minimized. For example, not only the forces propelling the transport element arise due to the magnetic field generated by a stator element. Highly attractive forces are also additionally generated between the stator element and the rotor section. On an arrangement of the stator unit/functional section pairings at both sides of the transport track, the described attractive forces compensate one another at least in part, whereby the guidance of the transport element can be configured more simply and smaller frictional forces occur.

A particularly good guidance of the transport element is achieved when the rollers are arranged symmetrically to a plane which coincides with a plane of symmetry of the stator elements and/or of the rotor element or which is arranged only slightly offset in parallel to the plane of symmetry, with the plane of symmetry extending in parallel to the longitudinal extent of the stator elements or of the rotor element. Forces acting perpendicular to the longitudinal extent of the rail between the stator element and the rotor element thereby act perpendicular on the rollers and tilting lever moments are minimized.

The transport apparatus can comprise a position monitoring system which comprises a coding arranged at the transport element and per stator element at least one reading device with which the coding can be detected. The reading device is in particular arranged at the stator element. Such a position monitoring system allows a precise control of the transport apparatus. The coding and the reading device can, for example, be based on an optical or magnetic process.

The present invention will be explained in the following purely by way of example with reference to advantageous embodiments and to the enclosed drawings. There are shown:

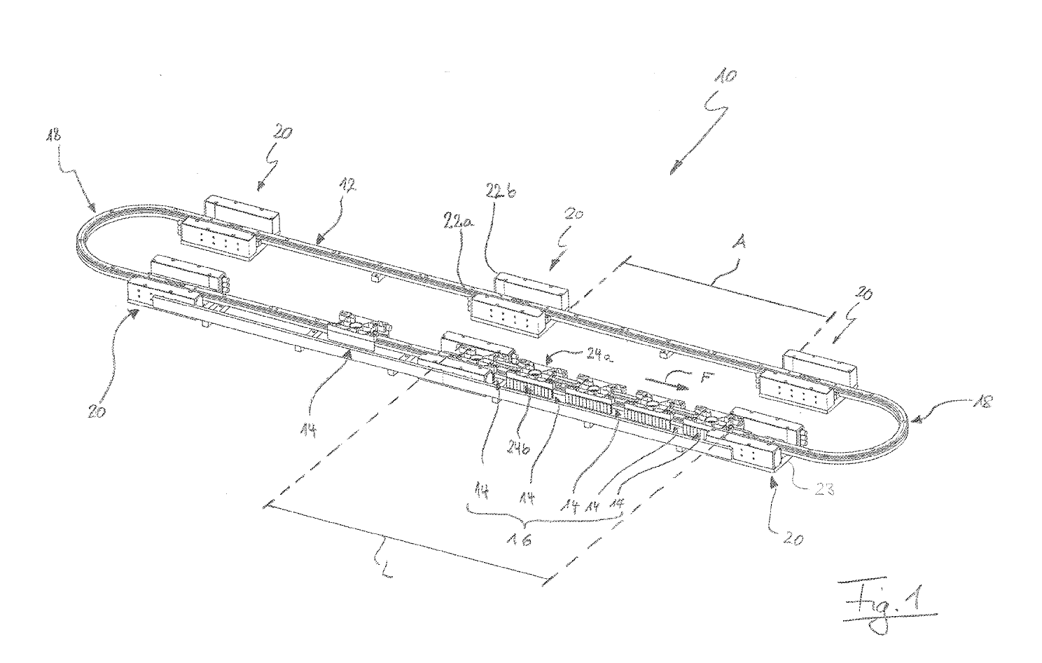

FIG. 1 an embodiment of the transport apparatus in accordance with the invention;

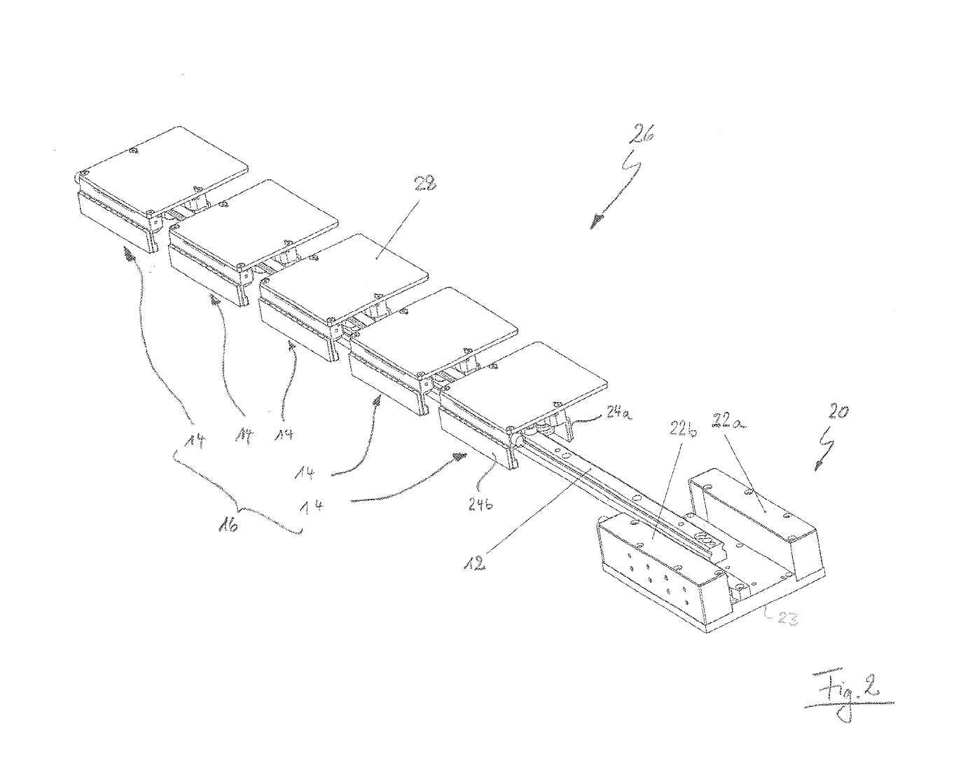

FIG. 2 a view of a module of the embodiment of the transport apparatus shown in FIG. 1;

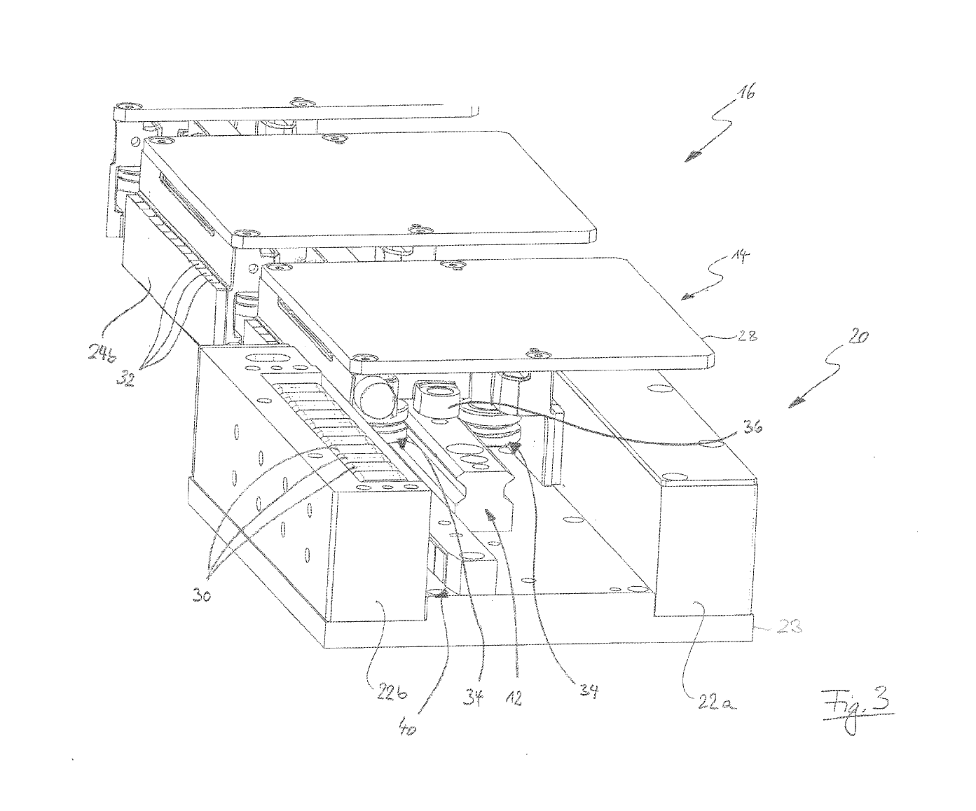

FIG. 3 a perspective view of a stator element and of a pallet train moving into it; and

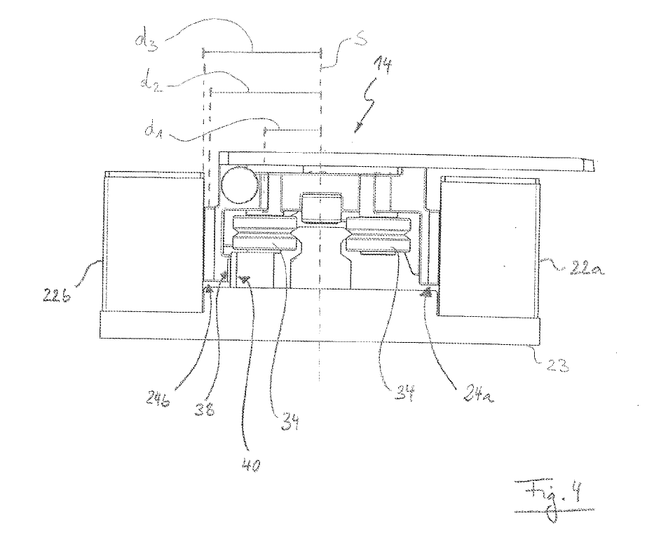

FIG. 4 a cross-section through a stator element and a pallet car.

FIG. 1 shows a transport apparatus 10 for the transport of objects along a rail 12 which defines a transport track along which the objects are transported.

The objects to be transported are arranged on transport platforms, not shown, of platform cars 14, which are combined to form a pallet train 16. An individual pallet car 14 is likewise shown. Due to a flexible coupling of the pallet cars 14 of the pallet train 16, curves 18 in the course of the rail 12 can be managed without any problem.

A drive of the pallet train 16 is based on the operating principle of a linear motor. Stators 20 are provided for this purpose which each have stator units 22a, 22b arranged symmetrically at both sides of the rail 12. The stator units 22a, 22b are each provided—as will be described in more detail in the following—with a plurality of coils. The stator units 22a, 22b are each arranged at a common base 23 which is also connected to the rail 12. The stator units 22a, 22b are thus only indirectly connected to the rail 12. They are therefore components functionally and spatially separate from the rail 12.

The rotor of the linear motor is ultimately formed by the pallet train 16. For this purpose, the pallet cars 14 have permanent magnet segments 24a, 24b which are each associated with the stator units 22a and 22b respectively. The pallet train 16 is in this respect of such a length L that at least one pallet car 14 is always at least partly located in the region of one of the stators 20.

It is shown in FIG. 1 that the pallet car 14 at the very front in the direction of travel F has already moved partly into the stator 20 at the bottom right, while the last pallet car 14 in the direction of travel F is still completely located in the region of the stator 20 disposed further to the front in the direction of travel F. A force can be exerted on the pallet train 16 by a suitable control of the two named stators 20, i.e. by a suitable application of current to their coils, to accelerate said pallet train, to decelerate it and/or to propel it at a predefined constant speed. An exact positioning of the pallet train 16 is also easily possible by a suitable control of the stators 20 to be able, for example, to process the objects arranged on the pallet cars 14.

Unlike conventional drive systems which have a substantially throughgoing stator, the drive system of the transport apparatus 10 has a simpler and therefore less expensive design. The respective distances A between adjacent stators 20 are always shorter than the length L of the pallet train 16 to ensure—as already described above—that at least one pallet car 14 (or its magnetic segments 24a, 24b) can always cooperate with the stator units 22a, 22b of one of the stators 20. The length of the curves 18 is also correspondingly coordinated.

It is understood that the distance A of the stators 20 has to be reduced on a use of a shorter pallet train 16 to satisfy the geometrical coordination of the two parameters (A<L) described several times above. Conversely, the pallet train 16 can easily be extended without additional stators 20 having to be provided.

The length L of the pallet train 16 is in particular at least as large as the sum of a maximum distance A between adjacent stators 20 and a stator length. It is thereby ensured that at least the propulsion force which can be generated by a stator 20 can be provided at all times if it is necessary.

Spacings result between the permanent magnet segments 24a, 24b of adjacent pallet cars 14 from the use of flexibly coupled pallet cars 14. The length of the stators 20 is, however, dimensioned such that it is larger than this spacing so that an always sufficiently long section of the permanent magnet segments 24a, 24b is arranged in the region of the stator units 22a, 22b to ensure a reliable monitoring of the pallet train 16.

Differing from the transport apparatus 10 shown, the rail 12 can generally define transport tracks of any desired configuration to meet the respective demands. Instead of a pallet train 16, an individual, correspondingly long pallet car 14 can also be used—if required and/or advantageous.

FIG. 2 shows a transport track module 26 which comprises a section of the rail 12 and one of the stators 20. A transport apparatus can substantially be composed of such modules 26, with provision being able to be made also to provide curved rail sections between different stators 20. It is admittedly generally also possible to provide stators 20 which adapt to a curved extent of the rail 12. However, the linear embodiment of the stators shown in FIGS. 1 and 2 is also preferred due to the simpler manner of construction.

In addition to the transport track module 26. FIG. 2 also shows the pallet train 16 in a perspective view. Unlike in FIG. 1, the coupled pallet cars 14 are now each provided with a working plate 28 on which the object to be transported can be arranged.

FIG. 3 shows a perspective view of one of the stators 20 having a pallet car 14 of the pallet train 16 which can be moved into it. The stator units 22a, 22b each have a plurality of coils 30 which cooperate with permanent magnets 32 of the permanent magnet segments 24a, 24b in accordance with a sufficiently known type of a linear motor. The magnetic fields which occur on an application of current to the coils 30 do not only generate a propulsion of the pallet car 14. As a “secondary product”, a high force is also generated which attracts the permanent magnet segments 24a, 24b to the respective stator unit 22a and 22b respectively. Since the forces acting between the component pairs 22a/24a and 22b/24b respectively, however, have the same direction, but an opposite sign, they substantially compensate one another so that the total force acting laterally on the pallet car 14 is minimized.

The pallet cars 14 also have, in addition to the already described work plate 28 and the permanent magnet segments 24a, 24b, rollers 34 which engage around the rail 12 and which cooperate with their sidewalls. Any residual components of the above-described attractive forces between the stator units 22a, 22b and the corresponding permanent magnet segments 24a and 24b respectively are taken up by this arrangement. A good centration of the rollers 34 is generated by a wedge-shaped design of a portion of the sidewalls of the rail 12 which engages into a correspondingly shaped groove of the rollers 34.

To couple the pallet cars 14, a respective coupling flange 36 is provided at the front side and/or rear side of the pallet cars 14.

FIG. 4 shows the components described with reference to FIG. 3 again in a cross-section, whereby the compact manner of construction of the drive system is illustrated. The manner of construction is characterized by a “nesting” of the corresponding components. I.e. the stator units 22a, 22b are arranged spaced apart from a central plane S of the rail 12 so that the pallet cars 14 can travel between them. A distance d₃ of the stator units 22a, 22b from the central plane S is consequently larger than a distance d₂ of the permanent magnet segments 24a, 24b from the central plane S. The rollers 34, whose axes of rotation have a distance d₁ from the central plane S, lie even further inwardly.

The stator units 22a, 22b are thus not integrated into the rail 12, which—compared with a drive concept which comprises stators integrated into the rail or directly fastened thereto—has as a consequence a simpler manner of construction of the drive system and thus cost advantages.

Apart from the rollers 34, no movable components are required for the operation of the transport apparatus 10, which ensures a low-maintenance and reliable operation. In addition, drive systems of the described type can be operated in an efficient manner since they are operationally based on the principle of a linear motor. At the same time, cost advantages are achieved with respect to conventional systems since the number of required coils 30 can be reduced, i.e. a long stator concept having a substantially continuous stator is replaced with a system which can be simply expanded, is low-maintenance and has a plurality of independent stators.

The pallet cars 14 are each provided with a coding strip 38 for an improved control of the movement of the pallet train 16. The information stored in it can be read out by reading heads 40. This information serves for the exact determination of the position of the pallet car 14 located in the region of the stator 20 and thus ultimately of the pallet train 16. Alternatively or additionally, the coding strip 38 can also contain other information such as information with respect to the object arranged on the corresponding pallet car 14.

On the use of only one reading head 40 per stator 20, the problem can occur under certain circumstances on a movement of the pallet train 16 that the reading head 40 does not receive any signal when one of the intermediate spaces passes it between adjacent pallet cars 14. The reading head 40 therefore generates an error signal and has to be reset, which can have the consequence of a brief interruption of the position monitoring. To prevent this, two reading heads 40 per stator 20 can be provided whose spacing in the direction of locomotion of the pallet train 16 is larger than the intermediate space between adjacent pallet cars 14. It is thereby ensured that always at least one of the reading heads 40 reads out a signal of the coding strip 38. With a suitable link of the reading heads 40 or on a suitable evaluation of their output signals, the position determination of the pallet train 16 and the control of its movement can therefore be improved.

It is also generally possible to use a coding strip 38 having a coding length which is longer than the transport track of the transport apparatus 10. The coding strip 38 is in this case applied to the pallet car 14 such that the absolute length information contained in the coding strip 38 correctly reproduces the length of the pallet train 16. In other words, the intermediate spaces between the individual pallet cars 14 have to be taken into account in that corresponding sections are removed from the coding strip 38. Which pallet car 14 is located where can thus be read out exactly by the reading head or heads 40. The coding strip 38 in this embodiment thus not only serves the position determination, but also allows the identification of the individual pallet cars 14.

### REFERENCE NUMERAL LIST

10 transport device
12 rail
14 pallet car
16 pallet train
18 curve
20 stator
22a, 22b stator unit
23 base
24a, 24b permanent magnet segment
26 transport track module
28 work plate
30 coil
32 permanent magnet
34 roller
36 coupling flange
38 coding strip
40 reading head
F direction of travel
A, d₁, d₂, d₃ distance
L length
S central plane

1-20. (canceled)

21. A transport apparatus for the transport of objects along a transport track (12) having a drive system which has at least two stationary stator elements (20), the stator elements being spaced apart from one another spatially and the stator elements being adapted to cooperate with a rotor element (24a, 24b), the rotor element being arranged at a transport element (16), with the transport element being suitable for receiving at least one object and being movable along the transport track (12), wherein a distance between the stator elements (20) in a direction parallel to the transport track (12) is smaller than the longitudinal extent of the rotor element (24a, 24b).

22. The transport apparatus in accordance with claim 1, wherein the spatial distance between the stator elements (20), the longitudinal extent of the stator elements (20) parallel to the transport track (12) and the longitudinal extent of the rotor element (24a, 24b) are coordinated with respect to one another such that one or more stator elements (20) cooperate with the rotor element (24a, 24b) at all times, with the sum of the sections of the stator elements (20) cooperating with the rotor element (24a, 24b) corresponding to at least the longitudinal extent of one of the stator elements (20) parallel to the transport track (12).

23. The transport apparatus in accordance with claim 1, wherein the spatial distance between the stator elements (20) is larger than half the longitudinal extent of the stator elements (20) parallel to the transport track (12).

24. The transport apparatus in accordance with claim 1, wherein a ratio of a sum of the longitudinal extents of the stator elements (20) parallel to the transport track (12) to a total length of the transport track (12) is at least one of smaller than 1:1.5 and lying between 1:3.5 and 1:5.5.

25. The transport apparatus in accordance with claim 1, wherein the stator elements (20) have at least one of substantially the same construction structure and a curve-free longitudinal extent.

26. The transport apparatus in accordance with claim 1, wherein the stator elements (20) comprise coils (30) which cooperate with permanent magnets (32) of the rotor element.

27. The transport apparatus in accordance with claim 1, wherein the stator elements (20) can be individually controlled; and/or wherein the stator elements (20) are connected in parallel and can be controlled together.

28. The transport apparatus in accordance with claim 1, wherein the rotor element is divided into segments (24a, 24b) which are arranged spatially separate from one another, viewed in the longitudinal direction of the transport track (12), such that at least one of the segments (24a, 24b) cooperates with one of the stator elements (20) at all times.

29. The transport apparatus in accordance with claim 1, wherein the transport element (16) comprises one of a plurality of transport units (14) which are coupled to one another and a plurality of transport units (14) of the same construction which are coupled to one another.

30. The transport apparatus in accordance with claim 8, wherein the transport element (16) comprises one of a plurality of transport units (14) which are coupled to one another and a plurality of transport units (14) of the same construction which are coupled to one another; and wherein at least one segment (24a, 24b) of the rotor element is associated with each transport unit (14).

31. The transport apparatus in accordance with claim 1, wherein the stator elements (20) are arranged separately from the transport track (12); and/or wherein the stator elements (20) are arranged offset in parallel to the transport track (12).

32. The transport apparatus in accordance with claim 11, wherein a spatial distance (d₃) between the stator elements (20) and the transport track (12) in a direction perpendicular to the longitudinal extent of the transport track (12) is larger than a spatial distance (d₂) between the rotor element (24a, 24b) and the transport track (12) in a direction perpendicular to the longitudinal extent of the transport track (12) and/or than a spatial distance (d₁) between a guide means (34) provided for guiding the transport element (16) along the transport track (12) and the transport track (12) in a direction perpendicular to the longitudinal extent of the transport track (12).

33. The transport apparatus in accordance with claim 11, wherein the rotor element (24a, 24b) is arranged such that it is arranged between the stator element (20) and the transport track (12) on passing a stator element (20).

34. The transport apparatus in accordance with claim 1, wherein a guide means (34) for guiding the movement of the transport element (16) along the transport track (12) is provided at the transport element (16), with the guide means (34) being arranged such that it is arranged between the stator element (20) and the transport track on passing a stator element (20).

35. The transport apparatus in accordance with claim 1, wherein the transport track comprises a rail (12) which conducts the transport element (16) along the transport track, with the transport element (16) comprising rollers (34) which are arranged disposed opposite one another with respect to the rail (12) and which are in contact with side surfaces of the rail (12).

36. The transport apparatus in accordance with claim 15, wherein the rollers (34) are arranged symmetrically to a plane which coincides with a plane of symmetry of the stator elements (20) and/or of the rotor element, with the plane of symmetry extending parallel to the longitudinal extent of the stator elements (20) or of the rotor element (24a, 24b).

37. The transport apparatus in accordance with claim 1, wherein the stator elements (20) each have at least two stator units (22a, 22b) which are arranged mutually opposite one another at both sides of a section of the transport track (12).

38. The transport apparatus in accordance with claim 17, wherein the rotor element has at least two functional sections (24a, 24b) which are arranged offset in parallel with respect to the transport track (12) and which each cooperate with one of the stator units (22a and 22b respectively).

39. The transport apparatus in accordance with claim 18, wherein the stator units (22a, 22b) and/or the functional sections (24a, 24b) are arranged symmetrically to a central plane (S) of the transport track (12) extending in the longitudinal direction of the transport track (12).

40. The transport apparatus in accordance with claim 1, wherein a position monitoring system is provided which comprises a coding (38) arranged at the transport element (16) and per stator element (20) at least one reading device (40) with which the coding (38) can be detected, and/or wherein the reading device (40) is arranged at the stator element (20).
